(19) United States
(12) Patent Application Publication
(10) Pub. No.: US 2024/0055627 A1
(43) Pub. Date: Feb. 15, 2024

(54) FUEL CELL MEMBRANE HUMIDIFIER AND FUEL CELL SYSTEM COMPRISING SAME

(71) Applicant: KOLON INDUSTRIES, INC., Seoul (KR)

(72) Inventors: Hyoung Mo YANG, Seoul (KR); Kyoung Ju KIM, Seoul (KR); Woong Jeon AHN, Seoul (KR); In Ho KIM, Seoul (KR)

(21) Appl. No.: 18/260,274

(22) PCT Filed: Jan. 21, 2022
(86) PCT No.: PCT/KR2022/001137

§ 371 Date: Jul. 3, 2023

(30) Foreign Application Priority Data
Jan. 28, 2021 (KR) 10-2021-0012277

(51) Int. Cl. H01M 8/04119; B01D 63/02; H01M 8/0662

(52) U.S. Cl. CPC H01M 8/04149; B01D 63/02; H01M 8/0687; H01M 8/04141; B01D 2313/201; B01D 2313/44; H01M 8/0276

(57) ABSTRACT

The present invention relates to a fuel cell membrane humidifier capable of improving humidification efficiency by performing two-stage humidification, and a fuel cell system comprising same. A fuel cell membrane humidifier according to an embodiment of the present invention comprises: a dry air supply means; a fuel cell membrane humidifier which performs two-stage humidification on the dry air supplied from the dry air supply means; a fuel cell stack for generating energy and humid exhaust gas by reacting the humidified air supplied from the fuel cell membrane humidifier with hydrogen; and a bypass flow path for bypassing a portion of the exhaust gas generated in the fuel cell stack. The fuel cell membrane humidifier comprises: a mid-case; a cap which is fastened with the mid-case and has a bypass inlet connected to the bypass flow path; a mixing humidifier which performs mixed humidification by mixing the dry air introduced through the cap and the exhaust gas introduced through the bypass inlet; and at least one cartridge which is disposed in the mid-case and accommodates a plurality of hollow fiber membranes that perform moisture exchange.

### TECHNICAL FIELD

The present invention relates to a fuel cell membrane humidifier and a fuel cell system comprising the same, and more specifically, to a fuel cell membrane humidifier capable of improving humidification efficiency by performing two-step humidification, and a fuel cell system comprising the same.

### BACKGROUND ART

Fuel cells are power generation cells that produce electricity through coupling between hydrogen and oxygen. The fuel cells have an advantage of being able to continuously produce electricity as long as the hydrogen and the oxygen are supplied, and having an efficiency that is about twice higher than an internal combustion engine because of no heat loss, unlike general chemical cells such as dry batteries or storage batteries.

Further, since chemical energy generated through coupling between the hydrogen and the oxygen is directly converted into electrical energy, emission of pollutants is reduced. Therefore, the fuel cells have an advantage of being environmentally friendly and being able to reduce concerns about resource depletion due to increased energy consumption.

These fuel cells are roughly classified into, for example, a polymer electrolyte membrane fuel cell (PEMFC), a phosphoric acid fuel cell (PAFC), a molten carbonate fuel cell (MCFC), a solid oxide fuel cell (SOFC), and an alkaline fuel cell (AFC) depending on a type of electrolyte used.

These fuel cells fundamentally operate according to the same principle, but have a difference in a type of fuel used, an operating temperature, a catalyst, an electrolyte, or the like. Among the cells, the polymer electrolyte membrane fuel cell (PEMFC) is known to be the most promising not only for small-scale stationary power generation equipment but also for transportation systems because the polymer electrolyte membrane fuel cell operates at a lower temperature than other fuel cells and can be miniaturized due to a high output density.

One of the most important factors in improving the performance of the polymer electrolyte membrane fuel cell (PEMFC) is to maintain moisture content by supplying a certain amount or more of moisture to a polymer electrolyte membrane (or proton exchange membrane: PEM) of a membrane electrode assembly (MEA). This is because the efficiency of power generation is rapidly degraded when the polymer electrolyte membrane is dried.

Examples of a method for humidifying the polymer electrolyte membrane include 1) a bubbler humidification scheme for filling a pressure-resistant container with water and then passing a target gas through a diffuser to supply moisture, 2) a direct injection scheme for calculating a moisture supply amount required for a fuel cell reaction and directly supplying moisture to a gas flow pipe through a solenoid valve, and 3) a humidification membrane scheme for supplying moisture to a fluidized gas layer using a polymer separation membrane.

Among these, the membrane humidification scheme for humidifying a polymer electrolyte membrane by providing water vapor to air supplied to the polymer electrolyte membrane using a membrane that selectively permeates only water vapor contained in an off-gas is advantageous in that a weight and size of a membrane humidifier can be reduced.

A selective permeable membrane used in the membrane humidification scheme is preferably a hollow fiber membrane having a large permeable area per unit volume when a module is formed. That is, when a membrane humidifier is manufactured using hollow fiber membranes, there are advantages that high integration of the hollow fiber membranes with a large contact surface area is possible so that a fuel cell can be sufficiently humidified even with a small capacity, low cost materials can be used, and moisture and heat contained in an off-gas discharged with a high temperature from the fuel cell can be recovered and can be reused through the membrane humidifier.

### DISCLOSURE

### Technical Problem

An object of the present invention is to provide a fuel cell membrane humidifier capable of improving humidification efficiency by performing two-step humidification, and a fuel cell system comprising the same.

### Technical Solution

A fuel cell membrane humidifier according to an embodiment of the present invention includes
a mid-case; caps fastened to the mid-case and having a bypass inlet connected to a bypass flow path, an off-gas discharged from a fuel cell stack being partially bypassed through the bypass flow path; a mixture humidification portion configured to mix a dry air flowing into the inside through the cap with an off-gas flowing into the inside through the bypass inlet to perform mixture humidification; and at least one cartridge disposed in the mid-case and configured to accommodate a plurality of hollow fiber membranes performing moisture exchange.

In the fuel cell membrane humidifier according to the embodiment of the present invention, the mixture humidification portion may be formed of a mesh structure made of activated carbon.

The fuel cell membrane humidifier according to the embodiment of the present invention may further include: a condensate water storage portion configured to be disposed in a lower portion of the cartridge and absorb and store condensate water in the mid-case; and a porous filter disposed between the cap and the cartridge.

In the fuel cell membrane humidifier according to the embodiment of the present invention, the condensate water storage portion may include a porous material diffusing and moving the stored condensate water toward a dry air input side.

The fuel cell membrane humidifier according to the embodiment of the present invention may further include a gasket assembly configured to airtightly couple between the mid-case and the cap through mechanical assembly so that the cap can be in fluid communication only with the hollow fiber membranes, and absorb a vibration of the cartridge.

In the fuel cell membrane humidifier according to the embodiment of the present invention, the gasket assembly may include a packing portion configured to include a hole, an end of the cartridge being inserted into the hole, and be in close contact with the end of the cartridge inserted into the hole, to absorb a vibration in a horizontal direction; an edge portion formed to be connected to the packing portion and interposed in a space formed by a groove formed at an end of the mid-case and an end of the cap; and a damping portion formed on an outer circumferential surface of the cartridge and configured to absorb a vibration in a vertical direction with a vertical movement of the damping portion suppressed by the packing portion.

In the fuel cell membrane humidifier according to the embodiment of the present invention, the packing portion may include a body member having a hole into which an end of the cartridge is inserted; and a protrusion member formed at one end of the body member and in close contact with the end of the cartridge inserted into the hole.

In the fuel cell membrane humidifier according to the embodiment of the present invention, at least a part of each of both ends of the condensate water storage portion may be formed in contact with the damping portion to support the damping portion.

In the fuel cell membrane humidifier according to the embodiment of the present invention, the porous filter may be disposed in contact with an upper surface of the gasket assembly, and a vibration in a vertical direction of the damping portion may be absorbed by the packing portion and the porous filter so that a vibration in a vertical direction of the cartridge is suppressed.

In the fuel cell membrane humidifier according to the embodiment of the present invention, the cartridge may include an inner case configured to have openings formed at ends thereof and accommodate the plurality of hollow fiber membranes; and potting portions, end portions of the plurality of hollow fiber membranes being fixed to the potting portions and the openings of the inner case being closed by the potting portions.

A fuel cell system according to an embodiment of the present invention includes a dry air supply means; a fuel cell membrane humidifier configured to perform two-step humidification on a dry air supplied from the dry air supply means; a fuel cell stack configured to cause a humidified air supplied from the fuel cell membrane humidifier to react with hydrogen to generate energy and a humid off-gas; and a bypass flow path configured to cause the off-gas generated in the fuel cell stack to be partially bypassed, wherein the fuel cell membrane humidifier includes a mid-case, caps fastened to the mid-case and having a bypass inlet connected to the bypass flow path, a mixture humidification portion configured to mix a dry air flowing into the inside through the cap with the off-gas flowing into the inside through the bypass inlet to perform mixture humidification; and at least one cartridge disposed in the mid-case and configured to accommodate a plurality of hollow fiber membranes performing moisture exchange.

In the fuel cell system according to the embodiment of the present invention, the mixture humidification portion may be formed of a mesh structure made of activated carbon.

The fuel cell system according to the embodiment of the present invention may further include a condensate water storage portion configured to be disposed in a lower portion of the cartridge and absorb and store condensate water in the mid-case; and a porous filter disposed between the cap and the cartridge.

In the fuel cell system according to the embodiment of the present invention, the condensate water storage portion may include a porous material diffusing and moving the stored condensate water toward a dry air input side.

The fuel cell system according to the embodiment of the present invention may further include a gasket assembly configured to airtightly couple between the mid-case and the cap through mechanical assembly so that the cap can be in fluid communication only with the hollow fiber membranes, and absorb a vibration of the cartridge.

In the fuel cell system according to the embodiment of the present invention, the gasket assembly may include a packing portion including a hole, an end of the cartridge being inserted into the hole, and being in close contact with the end of the cartridge inserted into the hole, to absorb a vibration in a horizontal direction; an edge portion formed to be connected to the packing portion and interposed in a space formed by a groove formed at an end of the mid-case and an end of the cap; and a damping portion formed on an outer circumferential surface of the cartridge and configured to absorb a vibration in a vertical direction with a vertical movement of the damping portion suppressed by the packing portion.

In the fuel cell system according to the embodiment of the present invention, the packing portion may include a body member having a hole into which an end of the cartridge is inserted; and a protrusion member formed at one end of the body member and in close contact with the end of the cartridge inserted into the hole.

In the fuel cell system according to the embodiment of the present invention, at least a part of each of both ends of the condensate water storage portion may be formed in contact with the damping portion to support the damping portion.

In the fuel cell system according to the embodiment of the present invention, the porous filter may be disposed in contact with an upper surface of the gasket assembly, and a vibration in a vertical direction of the damping portion may be absorbed by the packing portion and the porous filter so that a vibration in a vertical direction of the cartridge is suppressed.

In the fuel cell system according to the embodiment of the present invention, the cartridge may include an inner case configured to have openings formed at ends thereof and accommodate the plurality of hollow fiber membranes; and potting portions, end portions of the plurality of hollow fiber membranes being fixed to the potting portions and the openings of the inner case being closed by the potting portions.

Other specific matters of implementation examples according to various aspects of the present invention are included in the detailed description below.

### Advantageous Effects

According to the present invention, it is possible to improve humidification efficiency by performing two-step humidification consisting of mixture humidification and exchange humidification.

Further, it is possible to prevent the condensate water from being pooled in the membrane humidifier, and to remove foreign materials included in the dry air flowing into the membrane humidifier, thereby improving the humidification efficiency of the fuel cell membrane humidifier.

### DESCRIPTION OF DRAWINGS

FIG. 1 is a view schematically illustrating a fuel cell system including a fuel cell membrane humidifier according to a first embodiment of the present invention.

FIG. 2 is an exploded perspective view illustrating the fuel cell membrane humidifier according to the first embodiment of the present invention.

FIG. 3 is a view schematically illustrating a fuel cell system including a fuel cell membrane humidifier according to an application example of the first embodiment of the present invention.

FIG. 4 is an exploded perspective view illustrating the fuel cell membrane humidifier according to the application example of the first embodiment of the present invention.

FIG. 5 is an exploded perspective view illustrating a fuel cell membrane humidifier according to a second embodiment of the present invention.

FIG. 6 is an exploded cross-sectional view illustrating the fuel cell membrane humidifier according to the second embodiment of the present invention

FIG. 7 is a combined cross-sectional view illustrating the fuel cell membrane humidifier according to the second embodiment of the present invention.

FIG. 8 is an exploded perspective view illustrating a fuel cell membrane humidifier according to a third embodiment of the present invention.

FIG. 9 is a combined cross-sectional view illustrating the fuel cell membrane humidifier according to the third embodiment of the present invention.

FIG. 10 is a combined cross-sectional view illustrating an application example of a fuel cell membrane humidifier according to the third embodiment of the present invention.

FIG. 11 is an exploded perspective view illustrating a fuel cell membrane humidifier according to a fourth embodiment of the present invention.

FIG. 12 is a combined cross-sectional view illustrating the fuel cell membrane humidifier according to the fourth embodiment of the present invention.

### MODE FOR DISCLOSURE

Since various changes may be made to the present invention, which may have several embodiments, specific embodiments will be illustrated and described in detail herein. However, it will be understood that this is not intended to limit the present invention to the specific embodiments, and all changes, equivalents, or substitutions included in the spirit and scope of the present invention are included.

The terms used herein are for the purpose of describing specific embodiments only and are not intended to limit the present invention. The singular forms “a,” “an” and “the” include the plural forms, unless the context clearly indicates otherwise. It will be understood that the terms “comprises,” “comprising,” “includes” and/or “including,” herein specify the presence of stated features, integers, steps, operations, elements, and/or components, but do not preclude the presence or addition of one or more other features, integers, steps, operations, elements, components, and/or groups thereof. Hereinafter, a fuel cell membrane humidifier according to embodiments of the present invention will be described with reference to the drawings.

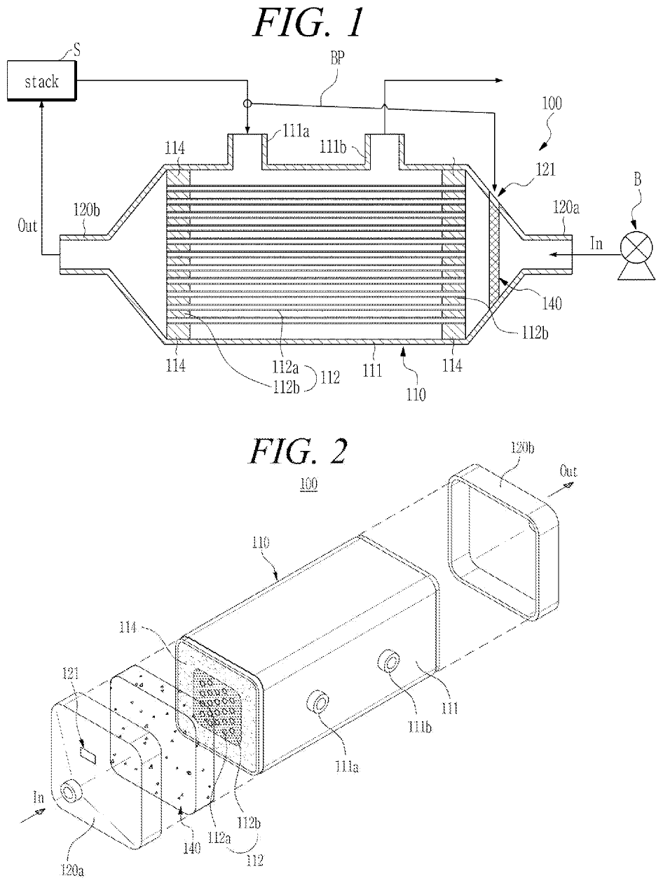

FIG. 1 is a view schematically illustrating a fuel cell system including a fuel cell membrane humidifier according to a first embodiment of the present invention.

Referring to FIG. 1, the fuel cell system including the fuel cell membrane humidifier according to the first embodiment of the present invention includes a dry air supply means B, a fuel cell membrane humidifier 100, a fuel cell stack S, and a bypass flow path BP.

The dry air supply means B receives outside air, compresses the outside air, and supplies the outside air to the fuel cell membrane humidifier 100. The dry air supply means B is a device that compresses a fluid such as air, and may be, for example, a blower or a compressor.

The fuel cell membrane humidifier 100 performs two-step humidification on dry air supplied from the dry air supply means B and supplies the air to the fuel cell stack S.

The fuel cell stack S causes the humidified air supplied from the fuel cell membrane humidifier 100 to react with hydrogen to generate energy and water. The water generated in the fuel cell stack S is supplied to the fuel cell membrane humidifier 100 in an off-gas form and used to humidify the dry air.

The bypass flow path BP supplies a part of the off-gas generated in the fuel cell stack S to a mixture humidification portion 140 formed in the cap 120a on the dry air input side through bypass.

The dry air supplied from the dry air supply means B to the fuel cell membrane humidifier 100 is primarily mixed with and humidified by a humid off-gas in the mixture humidification portion 140, secondarily humidified through moisture exchange with the off-gas in the humidification module 110, and then, is supplied to the fuel cell stack S.

A fuel cell membrane humidifier 100 that performs two-step humidification will be described with reference to FIG. 2. FIG. 2 is an exploded perspective view illustrating the fuel cell membrane humidifier according to the first embodiment of the present invention.

As illustrated in FIG. 2, the fuel cell membrane humidifier 100 according to the first embodiment of the present invention includes a humidification module 110 that humidifies the dry air supplied from the dry air supply means B with moisture in the off-gas discharged from the fuel cell stack S. Both ends of the humidification module 110 are coupled to caps 120 (120a and 120b). The mixture humidification portion 140 is formed in the cap 120a on the dry air input side. Further, a bypass inlet 121 through which the off-gas supplied from the bypass flow path BP flows into the inside is formed in the cap 120a.

The one cap 120a between the caps 120 supplies air supplied from the outside to the humidification module 110, and the other cap 120b supplies the air humidified by the humidification module 110 to the fuel cell stack S.

The humidification module 110 is a device in which moisture exchange occurs between the air supplied from the outside and the off-gas, and may include a mid-case 111 having an off-gas inlet 111a and an off-gas outlet 111b, and at least one cartridge 112 disposed in the mid-case 111.

The mid-case 111 and the cap 120 may be independently formed of hard plastic or metal, and may have a cross section in a width direction having a circular or polygonal shape. The “circular shape” includes an oval shape, and the “polygonal shape” includes a polygonal shape with rounded corners. Examples of the hard plastic may include polycarbonate, polyamide (PA), polyphthalamide (PPA), and polypropylene (PP).

The cartridge 112 may include a plurality of hollow fiber membranes 112a and a potting portion 112b that fixes the hollow fiber membranes 112a to each other. Ends of the hollow fiber membranes 112a may be fixed to the potting portion 112b.

The hollow fiber membranes 112a may include a polymer membrane formed of a polysulfone resin, a polyethersulfone resin, a sulfonated polysulfone resin, a polyvinylidene fluoride (PVDF) resin, a polyacrylonitrile (PAN) resin, a polyimide resin, a polyamideimide resin, a polyesterimide resin, or a mixture of two or more of these, and the potting portions 112b may be formed by curing a liquid resin such as a liquid polyurethane resin through a casting scheme such as deep potting or centrifugal potting.

The gas supplied from the outside flows along hollows of the hollow fiber membranes 112a. The off-gas flowing into the mid-case 111 through the off-gas inlet 111a comes into contact with outer surfaces of the hollow fiber membranes 112a and then is discharged from the mid-case 111 through the off-gas outlet 111b. When the off-gas comes into contact with the outer surfaces of the hollow fiber membranes 112a, moisture contained in the off-gas permeates the hollow fiber membranes 112a to humidify the air flowing along the hollows of the hollow fiber membranes 112a.

A resin layer 114 may be formed between the potting portion 112b and the mid-case 111. The resin layer 114 blocks inner spaces of the caps 120 and an inner space of the mid-case 111. The resin layer 114 is generally formed by curing a liquid polymer such as liquid polyurethane resin through a casting scheme, similar to the potting portion 112b.

The mixture humidification portion 140 receives the off-gas flowing through the bypass flow path BP through the bypass inlet 121. The mixture humidification portion 140 may be formed in a direction substantially perpendicular to a direction of the hollow fiber membrane 112a in a space between the cap 120a on the dry air input side and the potting portion 112b. The mixture humidification portion 140 may be formed in a mesh structure made of activated carbon. The mixture humidification portion 140 stores an off-gas containing water that flows into the inside through the bypass inlet 121. When a high-temperature dry air flowing into the inside through the cap 120a passes through the mixture humidification portion 140 having the activated carbon mesh structure, the humid off-gas stored in the mixture humidification portion 140 evaporates and primarily humidifies the dry air. In this case, since the humidification is performed through mixture of the water with the dry air, the humidification is called mixture humidification.

The dry air primarily humidified by the mixture humidification portion 140 flows into the humidification module 110, and performs moisture exchange with the off-gas flowing into the inside through the off-gas inlet 111a inside the humidification module 110 so that the dry air is secondarily humidified. The humidification in this case is called exchange humidification because the humidification is performed through the moisture exchange through the hollow fiber membranes 112a.

Thus, with the fuel cell membrane humidifier 100 according to the first embodiment of the present invention, it is possible to improve humidification efficiency by performing two-step humidification consisting of the mixture humidification and the exchange humidification.

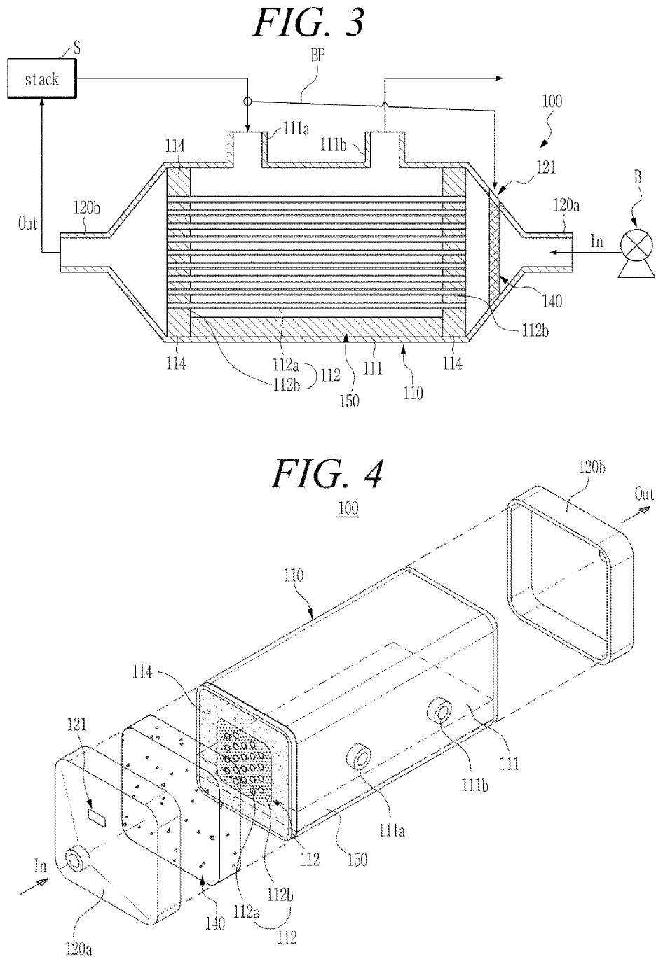

Meanwhile, a condensate water storage portion 150 that absorbs and stores condensate water condensed in the mid-case 111 may be additionally formed in a lower portion of the cartridge 112, as illustrated in FIGS. 3 and 4. The condensate water storage portion 150 absorbs and stores the condensate water in the mid-case 111 to prevent the condensate water from being pooled in the membrane humidifier.

The condensate water storage portion 150 preferably includes a porous material having high water absorption and high air resistance. The condensate water storage portion 150 may include activated carbon that is the porous material. The activated carbon is a material that has high adsorbability and is mainly formed of a carbonaceous material. The condensate water storage portion 150 may include a storage case (not illustrated) in which the porous material is accommodated and of which an upper portion is open.

In a fuel cell operation, condensate water generated on the humidified air discharge side connecting the membrane humidifier to the fuel cell stack is absorbed by and stored in the condensate water storage portion 150 including the porous material such as the activated carbon. Meanwhile, the condensate water stored in the condensate water storage portion 150 may move to the side from which the dry air flows into the inside while being diffused through a porous structure. The dry air flowing into the inside evaporates the water transferred through the diffusion in the condensate water storage portion 150 so that the water is recirculated to the inside of the hollow fiber membranes, and such a process allows the condensate water condensed in the mid-case 111 to be minimized or eliminated.

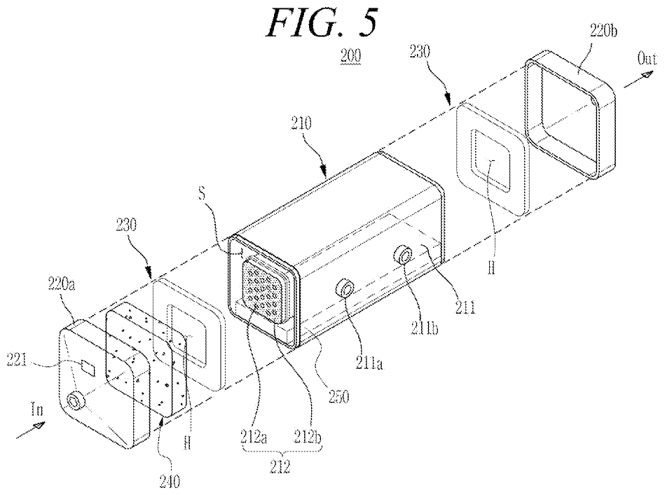

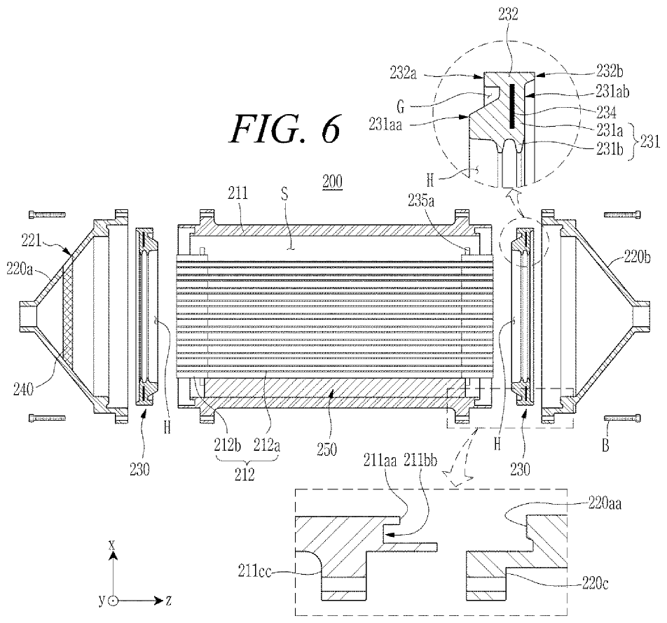

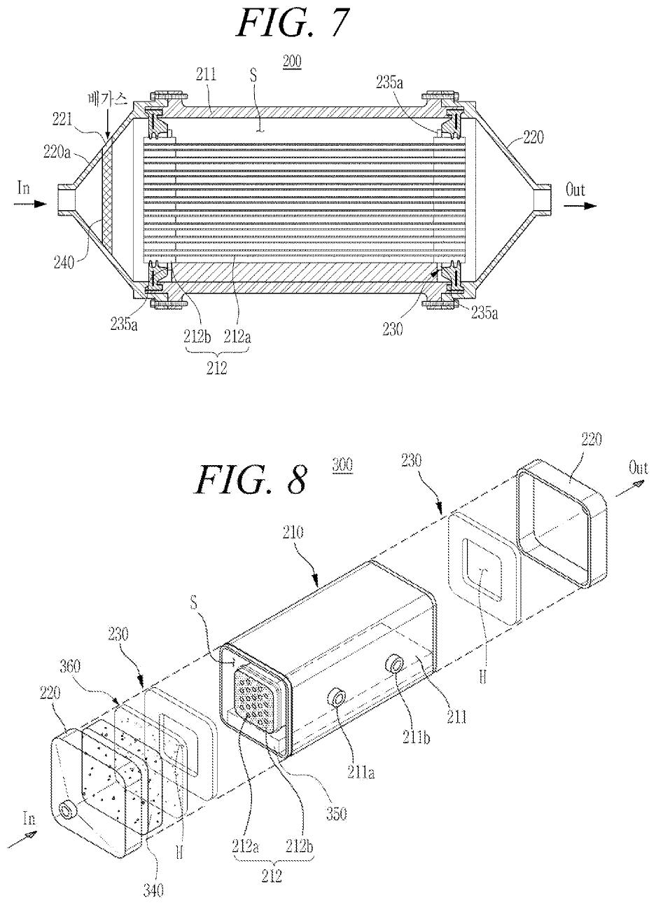

Next, a fuel cell membrane humidifier according to a second embodiment of the present invention will be described with reference to FIGS. 5 to 7. FIG. 5 is an exploded perspective view illustrating the fuel cell membrane humidifier according to the second embodiment of the present invention, FIG. 6 is an exploded cross-sectional view illustrating the fuel cell membrane humidifier according to the second embodiment of the present invention, and FIG. 7 is a combined cross-sectional view illustrating the fuel cell membrane humidifier according to the second embodiment of the present invention.

Since a humidification module 210, a mid-case 211, an off-gas inlet 211a, an off-gas outlet 211b, a cartridge 212, hollow fiber membranes 212a, a potting portion 212b, a cap 220 (220a and 220b), a mixture humidification portion 140 240, a condensate water storage portion 250, and the like are substantially the same as the humidification module 110, the mid-case 111, the off-gas inlet 111a, the off-gas outlet 111b, the cartridge 112, the hollow fiber membranes 112a, the potting portion 112b, the cap 120 (120a and 120b), the mixture humidification portion 140, the condensate water storage portion 150, and the like, repeated descriptions will be omitted.

Meanwhile, in the first embodiment described above, since a casting process for forming the resin layer 114 requires a relatively long process time, the productivity of the humidifier 100 is degraded. Further, since the resin layer 114 is adhered to an inner wall of the mid-case 111 as well as the potting portion 112b, the entire humidification module 110 should be replaced and high maintenance costs are caused when a problem occurs with the hollow fiber membranes 112.

Further, a repetitive operation of the fuel cell applies disturbance such as vibration and shock to the cartridge 212 in which the plurality of hollow fiber membranes 212a are accommodated, and such disturbance cause generation of a gap between the cartridge 212 and the mid-case 111, so that air leakage occurs due to a pressure difference, an amount of humidified air supplied to the fuel cell stack is reduced, and the efficiency of power generation of the fuel cell is degraded.

In order to solve this problem, the fuel cell membrane humidifier 200 according to the second embodiment of the present invention further includes a gasket assembly 230 that is airtightly coupled to each end of the humidification module 210 through mechanical assembly, as illustrated in FIGS. 5 to 7.

The gasket assembly 230 includes a packing portion 231, an edge portion 232, and a damping portion 235a. The packing portion 231 and the edge portion 232 may be formed of an elastic material (for example, silicone or rubber) having a first hardness of 20 to 70 Shore A and, preferably, 30 to 60 Shore A.

The packing portion 231 includes a hole H into which an end (for example, the potting portion 212b) of the cartridge 212 is inserted, and is interposed between the mid-case 211 and the cartridge 212. The packing portion 231 includes a body member 231a and a protrusion member 231b.

The body member 231a includes a hole H into which an end of the cartridge 212 is inserted, and the hole H is formed in a shape corresponding to that of the end of the cartridge 212. A lower body member 231aa formed to protrude from the body member 231a toward the mid-case 211 may be formed in a polygonal cross section shape (for example, a trapezoidal shape), and an upper body member 23 lab formed toward the cap 220 may be formed in a planar shape. A groove G into which an end 211aa of the mid-case 211 is fitted is formed between the lower body member 231aa and the edge portion 232.

The protrusion member 231b is formed at one end of the body member 231a to come into contact with the cartridge potting portion 212b inserted into the hole H. The protrusion member 231b may be at least one annular protrusion protruding from the one end of the body member 231a. The protrusion member 231b presses and comes into close contact with the cartridge potting portion 212b according to an elastic force to make a space of the mid-case 211 and a space of the cap 220 airtight. Therefore, the protrusion member 231b can prevent a fluid in the mid-case 211 from flowing into the space formed on the cap 120 side. Further, since the protrusion member 231b has elasticity, the protrusion member 231b can absorb a vibration in a horizontal direction (x- and y-axis directions in FIG. 3) of the cartridge 212, thereby reducing disturbance caused by the vibration and preventing air leakage due to a pressure difference between the mid-case 211 and the cap 220.

The edge portion 232 is formed at the other end of the body member 231a. The edge portion 232 may be interposed in a space formed by a groove 211b formed at an end of the mid-case and an end 220a of the cap. The edge portion 232 may include edge wings 232a and 232b protruding in both directions. The edge wings 232a and 232b may be formed in a longitudinal direction of the humidification module 210. When assembling is performed, the edge wings 232a and 232b are inserted into the groove 211b at the end of the mid-case, the edge wing 232b is pressed by the end 220a of the cap, and then, assembly is performed by fastening using a fastening means such as a bolt B. In this case, since the edge wings 232a and 232b are made of an elastic material, the edge wings 232a and 232b may be interposed with a space of the groove 211b at the end of the mid-case partially filled with the edge wings 232a and 232b. Fastening fragments 211c and 220c having fastening holes for fastening bolts may be formed on side surfaces of ends of the mid-case 211 and the cap 220. The edge wings 232a and 232b may make the groove 211b at the end of the mid-case airtight to seal the inside and outside of the mid-case 211, and the mid-case 211, and the cap 220.

The damping portion 235a may be formed to protrude radially from an outer circumferential surface of the cartridge potting portion 212b. The damping portion 235a may be formed in an annular ring shape on an outer surface of the cartridge potting portion 212b after the cartridge potting portion 212b is formed. The damping portion 235a may be formed so that at least a part of the damping portion 235a comes into contact with a lower surface of the packing portion 231. Specifically, the damping portion 235a may be formed so that the at least a part of the damping portion 235a comes into contact with a lower surface of the lower body member 231aa. Such a packing portion 231 may absorb a vibration in a vertical direction of the cartridge 212 with a movement in a vertical direction (a z-axis direction in FIG. 3) of the packing portion 231 suppressed by the damping portion 235a. This makes it possible to reduce disturbance due to vibration.

That is, the packing portion 231 can absorb the vibration in the horizontal direction of the cartridge 212 and the damping portion 235a can absorb the vibration in the vertical direction of the cartridge 212, thereby reducing disturbance caused by the vibration and preventing air leakage due to a pressure difference between the mid-case 211 and the cap 220.

Further, the gasket assembly 230 may further include a reinforcing member 234. The reinforcing member 234 may have a second hardness higher than the first hardness. For example, the reinforcing member 234 may be formed of metal, a thermoplastic or thermosetting resin, or the like. The reinforcing member 234 may be formed to be inserted into the gasket assembly 230 by being manufactured after a metal plate is inserted into a mold at the time of molding of the gasket assembly 230. The reinforcing member 234 may be formed to be inserted into at least a part of the packing portion 231 and at least a part of the edge portion 232. The reinforcing member 234 may be formed at a portion of the gasket assembly 230 that is vulnerable to deformation (a portion in which the groove G is formed). The reinforcing member 234 having a hardness higher than the packing portion 231 and the edge portion 232 can prevent the body member 231a from being deformed when the gasket assembly 230 is mechanically assembled into the humidification module 210 or while the humidifier is operating, to block air leakage more reliably.

A condensate water storage portion 250 that absorbs and stores condensate water condensed in the mid-case 211 may be formed in a lower portion of the cartridge 212. The condensate water storage portion 250 absorbs and stores the condensate water in the mid-case 211 to prevent the condensate water from being pooled in the membrane humidifier.

Meanwhile, in the present embodiment, both ends of the condensate water storage portion 250 may be fixed by the damping portion 235a. Specifically, at least a part of both the ends of the condensate water storage portion 250 may be formed to come into contact with the damping portion 235a. Accordingly, the condensate water storage portion 250 supports the damping portion 235a, and the damping portion 235a can absorb a vibration in a vertical direction of the cartridge 212 with a movement in a vertical direction (the z-axis direction in FIG. 3) of the damping portion 235a suppressed by the packing portion 231. This makes it possible to reduce disturbance due to vibration.

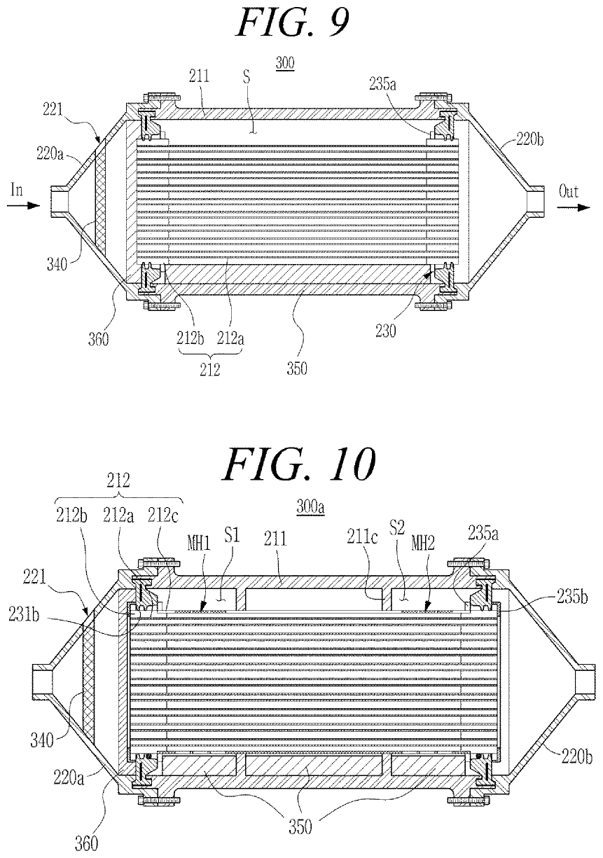

Next, a fuel cell membrane humidifier according to a third embodiment of the present invention will be described with reference to FIGS. 8 and 9. FIG. 8 is an exploded perspective view illustrating the fuel cell membrane humidifier according to the third embodiment of the present invention, and FIG. 9 is a combined cross-sectional view illustrating the fuel cell membrane humidifier according to the third embodiment of the present invention.

Referring to FIGS. 8 and 9, the fuel cell membrane humidifier 300 according to the third embodiment of the present invention further includes a porous filter 360 in addition to the second embodiment described above.

A condensate water storage portion 350 that absorbs and stores condensate water condensed in the mid-case 211 may be formed in a lower portion of the cartridge 212, as in the second embodiment described above. The condensate water storage portion 350 absorbs and stores the condensate water in the mid-case 211 to prevent the condensate water from being pooled in the membrane humidifier.

The porous filter 360 may be disposed between the cap 220a on the dry air input side In and the humidification module 210. Specifically, the porous filter 360 may be disposed between the cap 220a on the dry air input side In and the gasket assembly 230. The porous filter 360 may be disposed in contact with the upper surface of the gasket assembly 230.

The porous filter 360 preferably includes a porous material having high water absorption and high air resistance. The porous filter 360 may include activated carbon, which is the porous material. The activated carbon is a material that has high adsorbability and is mainly formed of a carbonaceous material. Therefore, the porous filter 360 can remove foreign materials contained in the dry air flowing into the membrane humidifier 300.

The dry air flowing into the inside through the cap 220a on the dry air input side (In) may be primarily subjected to the mixture humidification by a mixture humidification portion 440, the foreign materials in the dry air may be removed by the porous filter 360, and then, the dry air may be secondarily subjected to the exchange humidification while flowing in the hollow fiber membrane 212a.

Meanwhile, since the porous filter 360 is formed in contact with the upper surface of the gasket assembly 230, the porous filter 360 can perform a damping function together with a filtering function. Specifically, since a lower surface of the gasket assembly 230 comes in contact with the damping portion 235a and the upper surface of the gasket assembly 230 comes in contact with the porous filter 360, a vibration in a vertical direction of the damping portion 235a into which the end of the cartridge 212 is inserted is absorbed by the packing portion 231 and the porous filter 360 so that a vibration in a vertical direction of the cartridge 212 can be suppressed.

Further, since the at least a part of each of both ends of the condensate water storage portion 350 is formed to come into contact with the damping portion 235a, the condensate water storage portion 350 supports the damping portion 235a, thereby further suppressing the vibration in the vertical direction of the cartridge 212.

FIG. 10 is a combined cross-sectional view illustrating an application example of a fuel cell membrane humidifier according to the third embodiment of the present invention.

As illustrated in FIG. 10, an application example 300a of the fuel cell membrane humidifier according to the third embodiment of the present invention is substantially the same as the fuel cell membrane humidifier 300 according to the second embodiment except that (i) an inner space of a mid-case 211 is partitioned into a first space S1 and a second space S2 by partition walls 211c, and (ii) a cartridge 212 further includes an inner case 212c.

The inner case 212c has an opening at each end, and hollow fiber membranes 212a are accommodated in the opening. Potting portions 212b to which ends of the hollow fiber membranes 212a are potted close the openings of the inner case 212c.

As illustrated in FIG. 10, at least a part of the potting portion 212b may be located outside the inner case 212c, and the protrusion member 231b of the gasket assembly 230 may come into close contact with the potting portion 212b. The damping portion 235a may be formed as an annular ring having a predetermined length on an outer circumferential surface of the inner case 212c.

The inner case 212c includes a plurality of holes (hereinafter referred to as ‘first mesh holes’) MH1 arranged in a mesh form for fluid communication with the first space S1, and a plurality of holes (hereinafter referred to as ‘second mesh holes’) MH2 arranged in a mesh form for fluid communication with the second space S2.

An off-gas flowing into the first space S1 of the mid-case 211 through an off-gas inlet 211a flows into the inner case 212c through the first mesh holes MH1 and comes into contact with outer surfaces of the hollow fiber membranes 212a. Subsequently, the off-gas deprived of moisture exits to the second space S2 through the second mesh holes MH2, and then, is discharged from the mid-case 211 through an off-gas outlet 211b.

Such a cartridge 212 including the inner case 212c has an advantage of being able to be easily assembled into the mid-case 211 and easily replaced.

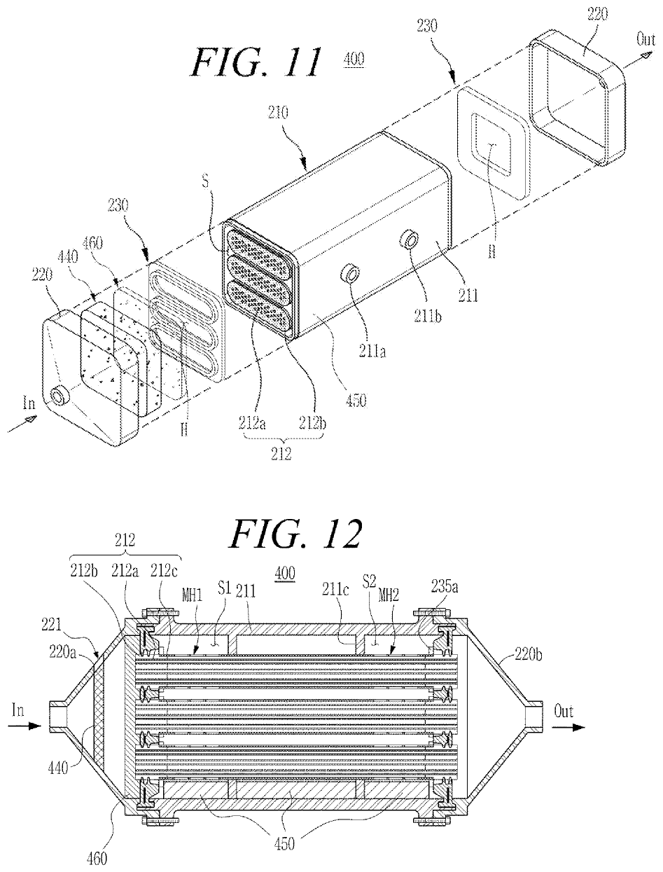

Meanwhile, the entire potting portion 212b may be located within the inner case 212c, and the protrusion member 23lb of the gasket assembly 230 may be manufactured to come into close contact with the inner case 212c rather than the potting portion 212b. Next, a fuel cell membrane humidifier according to a fourth embodiment of the present invention will be described with reference to FIGS. 11 and 12. FIG. 11 is an exploded perspective view illustrating the fuel cell membrane humidifier according to the fourth embodiment of the present invention, and FIG. 12 is a combined cross-sectional view illustrating the fuel cell membrane humidifier according to the fourth embodiment of the present invention.

As illustrated in FIGS. 11 and 12, the fuel cell membrane humidifier 400 according to the fourth embodiment of the present invention is substantially the same as the fuel cell membrane humidifier 300a according to the embodiment described above except that (i) a humidification module 210 includes two or more cartridges 212, (ii) a body member 231a of a packing portion 231 includes two or more holes H into which cartridges 212 are inserted, (iii) two or more protrusion members 231b formed at one end of a body member 231a to come into contact with a cartridge potting portion 212b are included, and (iv) a damping portion 235a formed on each of outer circumferential surfaces of the two or more cartridges is included.

A plurality of cartridges 212 each including an inner case 212c are mounted in a mid-case 211 at regular intervals, making it possible to uniformly distribute an off-gas to all hollow fiber membranes 212a present in the mid-case 211, and to selectively replace only the specific cartridge 212 in which a problem occurs, thereby further reducing a maintenance cost of the fuel cell membrane humidifier 400.

Non-explained reference numeral 440 denotes a mixture humidification portion, 450 denotes a condensate water storage portion, and 460 denotes a porous filter, which are substantially the same as those in the above-described embodiment, and thus repeated description thereof will be omitted.

Although the embodiments of the present invention have been described above, those skilled in the art can variously modify or change the present invention through affixation, change, deletion, addition, or the like of components without departing from the spirit of the present invention described in the claims, and this will be said to be also included within the scope of the present invention.

### DETAILED DESCRIPTION OF MAIN ELEMENTS

100, 200, 300, 400: fuel cell membrane humidifier
110, 210: humidification module 111, 211: mid-case
111a, 211a: off-gas inlet 111b, 211b: off-gas outlet
211c: partition wall 112, 212: cartridge
112a, 212a: hollow fiber membrane 112b, 212b: potting portion
212c: inner case 120, 220: cap
230: gasket assembly
140, 240, 340, 440: mixture humidification portion
150, 250, 350, 450: condensate water storage portion
360, 460: porous filter

1. A fuel cell membrane humidifier comprising:
a mid-case;
caps fastened to the mid-case and having a bypass inlet connected to a bypass flow path, an off-gas discharged from a fuel cell stack being partially bypassed through the bypass flow path;
a mixture humidification portion configured to mix a dry air flowing into the inside through the cap with an off-gas flowing into the inside through the bypass inlet to perform mixture humidification; and
at least one cartridge disposed in the mid-case and configured to accommodate a plurality of hollow fiber membranes performing moisture exchange.

2. The fuel cell membrane humidifier of claim 1, wherein the mixture humidification portion is formed of a mesh structure made of activated carbon.

3. The fuel cell membrane humidifier of claim 1, further comprising:
a condensate water storage portion configured to be disposed in a lower portion of the cartridge and absorb and store condensate water in the mid-case; and
a porous filter disposed between the cap and the cartridge.

4. The fuel cell membrane humidifier of claim 3, wherein the condensate water storage portion includes a porous material diffusing and moving the stored condensate water toward a dry air input side.

5. The fuel cell membrane humidifier of claim 3, further comprising a gasket assembly configured to airtightly couple between the mid-case and the cap through mechanical assembly so that the cap can be in fluid communication only with the hollow fiber membranes, and absorb a vibration of the cartridge.

6. The fuel cell membrane humidifier of claim 5, wherein the gasket assembly includes
a packing portion configured to include a hole, an end of the cartridge being inserted into the hole, and be in close contact with the end of the cartridge inserted into the hole, to absorb a vibration in a horizontal direction;
an edge portion formed to be connected to the packing portion and interposed in a space formed by a groove formed at an end of the mid-case and an end of the cap; and
a damping portion formed on an outer circumferential surface of the cartridge and configured to absorb a vibration in a vertical direction with a vertical movement of the damping portion suppressed by the packing portion.

7. The fuel cell membrane humidifier of claim 6, wherein the packing portion includes
a body member having a hole into which an end of the cartridge is inserted; and
a protrusion member formed at one end of the body member and in close contact with the end of the cartridge inserted into the hole.

8. The fuel cell membrane humidifier of claim 6, wherein at least a part of each of both ends of the condensate water storage portion is formed in contact with the damping portion to support the damping portion.

9. The fuel cell membrane humidifier of claim 6, wherein the porous filter is disposed in contact with an upper surface of the gasket assembly, and a vibration in a vertical direction of the damping portion is absorbed by the packing portion and the porous filter so that a vibration in a vertical direction of the cartridge is suppressed.

10. The fuel cell membrane humidifier of any one of claim 1, wherein the cartridge includes
an inner case configured to have openings formed at ends thereof and accommodate the plurality of hollow fiber membranes; and
potting portions, end portions of the plurality of hollow fiber membranes being fixed to the potting portions and the openings of the inner case being closed by the potting portions.

11. A fuel cell system comprising:
a dry air supply means;
a fuel cell membrane humidifier configured to perform two-step humidification on a dry air supplied from the dry air supply means;
a fuel cell stack configured to cause a humidified air supplied from the fuel cell membrane humidifier to react with hydrogen to generate energy and a humid off-gas; and
a bypass flow path configured to cause the off-gas generated in the fuel cell stack to be partially bypassed, wherein the fuel cell membrane humidifier includes
a mid-case,
caps fastened to the mid-case and having a bypass inlet connected to the bypass flow path,
a mixture humidification portion configured to mix a dry air flowing into the inside through the cap with the off-gas flowing into the inside through the bypass inlet to perform mixture humidification; and
at least one cartridge disposed in the mid-case and configured to accommodate a plurality of hollow fiber membranes performing moisture exchange.

12. The fuel cell system of claim 11, wherein the mixture humidification portion is formed of a mesh structure made of activated carbon.

13. The fuel cell system of claim 11, further comprising:
a condensate water storage portion configured to be disposed in a lower portion of the cartridge and absorb and store condensate water in the mid-case; and
a porous filter disposed between the cap and the cartridge.

14. The fuel cell system of claim 13, wherein the condensate water storage portion includes a porous material diffusing and moving the stored condensate water toward a dry air input side.

15. The fuel cell system of claim 13, further comprising a gasket assembly configured to airtightly couple between the mid-case and the cap through mechanical assembly so that the cap can be in fluid communication only with the hollow fiber membranes, and absorb a vibration of the cartridge.

16. The fuel cell system of claim 15, wherein the gasket assembly includes
a packing portion including a hole, an end of the cartridge being inserted into the hole, and being in close contact with the end of the cartridge inserted into the hole, to absorb a vibration in a horizontal direction;
an edge portion formed to be connected to the packing portion and interposed in a space formed by a groove formed at an end of the mid-case and an end of the cap; and
a damping portion formed on an outer circumferential surface of the cartridge and configured to absorb a vibration in a vertical direction with a vertical movement of the damping portion suppressed by the packing portion.

17. The fuel cell system of claim 16, wherein the packing portion includes
a body member having a hole into which an end of the cartridge is inserted; and
a protrusion member formed at one end of the body member and in close contact with the end of the cartridge inserted into the hole.

18. The fuel cell system of claim 16, wherein at least a part of each of both ends of the condensate water storage portion is formed in contact with the damping portion to support the damping portion.

19. The fuel cell system of claim 16, wherein the porous filter is disposed in contact with an upper surface of the gasket assembly, and a vibration in a vertical direction of the damping portion is absorbed by the packing portion and the porous filter so that a vibration in a vertical direction of the cartridge is suppressed.

20. The fuel cell system of any one of claim 11, wherein the cartridge includes
an inner case configured to have openings formed at ends thereof and accommodate the plurality of hollow fiber membranes; and
potting portions, end portions of the plurality of hollow fiber membranes being fixed to the potting portions and the openings of the inner case being closed by the potting portions.
